(19) United States
(12) Patent Application Publication
(10) Pub. No.: US 2023/0306454 A1
(43) Pub. Date: Sep. 28, 2023

(54) ACCOUNT MANAGEMENT WITH REAL-TIME INCENTIVE

(71) Applicant: FYNCR INC., TORONTO (CA)

(72) Inventor: Sahil Kumar, Toronto (CA)

(21) Appl. No.: 17/977,145

(22) Filed: Oct. 31, 2022

Related U.S. Application Data
(60) Provisional application No. 63/274,337, filed on Nov. 1, 2021.

(51) Int. Cl. G06Q 30/0207; G06Q 20/38

(52) U.S. Cl. CPC G06Q 30/0207; G06Q 20/3821

(57) ABSTRACT

Disclosed herein are systems and methods for account management with real-time incentives. For example, a method includes receiving one or more account identifiers identifying a financial account associated with a user. The method further includes receiving a payment request including a payment amount, a credit account selection from the one or more account identifiers, and a payment account selection from the one or more account identifiers. Upon receiving the payment request, the method includes transmitting a first financial transfer request to an electronic system associated with a bank account, causing the bank account to receive a first payment from the selected payment account and transmitting a second financial transfer request to the electronic system, causing the electronic system to transfer a second payment to the selected credit account. The method includes generating the incentive based on the payment amount and providing a notification to the user.

### FIELD OF THE INVENTION

The present invention is in the field of electronic payment and deposit systems and services and pertains particularly to methods for facilitating and managing electronic deposits from payer to payee accounts through a common electronic payment interface providing real-time incentives.

### BACKGROUND OF THE INVENTION

There is more than $1.2 trillion credit card debt in the United States. The number of credit-card accounts per capita is also greatest in the U.S. The average user on a credit card bill of $1,000 only pays back $100 per month. Electronic payment and billing services enable users to transact payments electronically. Typically, electronic payment and billing systems are provided by financial institutions and are tailored for the offerings of each financial institution. Users may have credit accounts with multiple financial institutions. For example, a bank that provides a checking account for a consumer may provide electronic online payment services for the consumer's payees but the services are typically adapted to work efficiently with the credit cards of that same bank (as an issuer) and thus limit the ability or capability of the online system to be able to connect to credit cards by other providers. Meaning, the system is configured to limit the effectiveness, efficiency, speed, or transparency in paying or managing credit cards. This is sort of a captive electronic user situation.

In these situations, transacting payments may require accessing multiple independent and disparate electronic payment and billing systems. It can also involve uncertainty about the status of the electronic payment or the credit card account. Users generally do not enjoy the experience of paying them back, as it is not rewarding or seamless. Having to access separate systems may impede the user's ability to effectively manage aggregate debt. Effective debt management may be beneficial to the user. Effective debt management may be further improved by incentives to make payments and/or reduce outstanding debt.

There is also often times a lack of transparency or status in these systems. The user may have taken the necessary steps to pay a credit card account using their financial institutions' online payment system (e.g., by a deadline) of their bank (their bank account provider) but what happens many times is that the payment may not have been handled properly by the account provider and the consumer is unaware of the status.

Also, under the current system in U.S. and other countries, each type of credit card, Visa, MasterCard, Discover, and American Express must be paid through a corresponding gateway that sits in front of a network banks or financial institutions that have issued credit card issuers. There are many thousands of cards and many issuing banks, with each bank having many different types of credit card types or categories (e.g., gold, select, silver, rewards plus, etc.). Each card and/or each bank and/or each gateway requires its own format, procedures, or information, and may have its own requirements to complete a payment in a credit card account. Each may also involve supplemental data or comments that is included the communications process. The information may also change over time such as when new cards are added. This creates a massive problem related to format, contents, and/or structures of messages, records, or communications across the many different systems.

There are many other advantages and problems being solved by the illustrative practical implementations provided herein.

### SUMMARY OF THE INVENTION

The present disclosure describes embodiments related to account management with real-time incentives. In an embodiment, a method of providing an incentive is disclosed. The method includes receiving, at a data processing device, one or more account identifiers, each account identifier identifying a financial account associated with a user. The method further includes receiving, at the data processing device, a payment request including a payment amount, a credit account selection from the one or more account identifiers, and a payment account selection from the one or more account identifiers. Upon receiving the payment request, the method includes: (a) transmitting, by the data processing device, a first financial transfer request to an electronic system associated with a bank account, the first financial transfer request causing the bank account to receive a first payment from the selected payment account, and (b) transmitting, by the data processing device, a second financial transfer request to the electronic system associated with the bank account, the second financial transfer request causing the electronic system to transfer a second payment to the selected credit account. The method further includes generating, by the data processing device, the incentive based on the payment amount and providing, by the data processing device, an incentive notification to the user.

Implementations of the disclosure may include one or more of the following optional features. In some implementations the method further includes receiving, from the user, at the data processing device, credentials associated with the selected credit account and validating, by the data processing device, the received credentials prior to transmitting the first financial transfer request. Validating the received credentials may include transmitting a validation request to an account validation service, the validation request causing the account validation service to validate the received credentials. The method may further include receiving, at the data processing device, an indication that the second payment was not credited to the selected credit account and, in response to the indication, diminishing, by the data processing device, the incentive. In some examples, the method includes receiving, at the data processing device, merchant program information indicating one or more products or services associated with the merchant and in response to determining, by the data processing device, that at least a portion of the second payment is for a product or service associated with the merchant, increasing the incentive. The method may further include transmitting to the user, by the data processing device, a merchant program message indicating one or more of the one or more products or services associated with the merchant. In some examples, the method includes transmitting to the user, by the data processing device, an incentive message indicating the generated incentive. The incentive message may include an email message. The payment request may include an autopayment request. The incentive notification may be provided substantially contemporaneously with receiving the payment request. And the bank account may be a floating bank account.

In an embodiment, a system is disclosed. The system includes a data processing device and a non-transitory computer-readable medium in communication with the data processing device, the data processing device configured to perform operations. The operations include receiving one or more account identifiers, each account identifier identifying a financial account associated with a user and receiving, at the data processing device, a payment request including a payment amount, a credit account selection from the one or more account identifiers, and a payment account selection from the one or more account identifiers. Upon receiving the payment request, the operations include transmitting, by the data processing device, a first financial transfer request to an electronic system associated with a bank account, the first financial transfer request causing the bank account to receive a first payment from the selected payment account and transmitting, by the data processing device, a second financial transfer request to the electronic system associated with the bank account, the second financial transfer request causing the electronic system to transfer a second payment to the selected credit account. The operations may further include generating, by the data processing device, an incentive based on the payment amount and providing, by the data processing device, an incentive notification to the user.

Implementations of the disclosure may include one or more of the following optional features. In some implementations the data processing device is further configured to perform operations including receiving from the user, at the data processing device, credentials associated with the selected credit account and validating, by the data processing device, the received credentials prior to transmitting the first financial transfer request. In some examples, validating the received credentials includes transmitting a validation request to an account validation service, the validation request causing the account validation service to validate the received credentials. The data processing device may be further configured to perform operations including receiving, at the data processing device, an indication that the second payment was not credited to the selected credit account and in response to the indication, diminishing, by the data processing device, the incentive. The data processing device may be further configured to perform operations including receiving, at the data processing device, merchant program information indicating one or more products or services associated with the merchant and in response to determining, by the data processing device, that at least a portion of the second payment is for a product or service associated with the merchant, increasing the incentive. In some examples, the data processing device is further configured to perform operations including transmitting to the user, by the data processing device, a merchant program message indicating one or more of the one or more products or services associated with the merchant. The data processing device may be further configured to perform operations including transmitting to the user, by the data processing device, an incentive message indicating the generated incentive. The incentive notification may be provided substantially contemporaneously with receiving the payment request. And the bank account may be a floating bank account.

### BRIEF DESCRIPTION OF THE DRAWINGS

FIG. 1 is a flowchart for an example system.

FIG. 2 is an architecture diagram for the example system.

FIGS. 3 and 4 are payment flow diagrams for the example system.

FIGS. 5A-5M show screen shots of an example user interface.

FIG. 6 is a block diagram of internal hardware included in any of the data processing components of this disclosure.

Like reference symbols in the various drawings indicate like elements.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or includes), but not limited to.” When used in this document, the term “exemplary” is intended to mean “by way of example” and is not intended to indicate that a particular exemplary item is preferred or required.

In this document, when terms such “first” and “second” are used to modify a noun or phrase, such use is simply intended to distinguish one item from another and is not intended to require a sequential order unless specifically stated. The term “about” when used in connection with a numeric value, is intended to include values that are close to, but not exactly, the number. For example, in some embodiments, the term “about” may include values that are within +/−10 percent of the value.

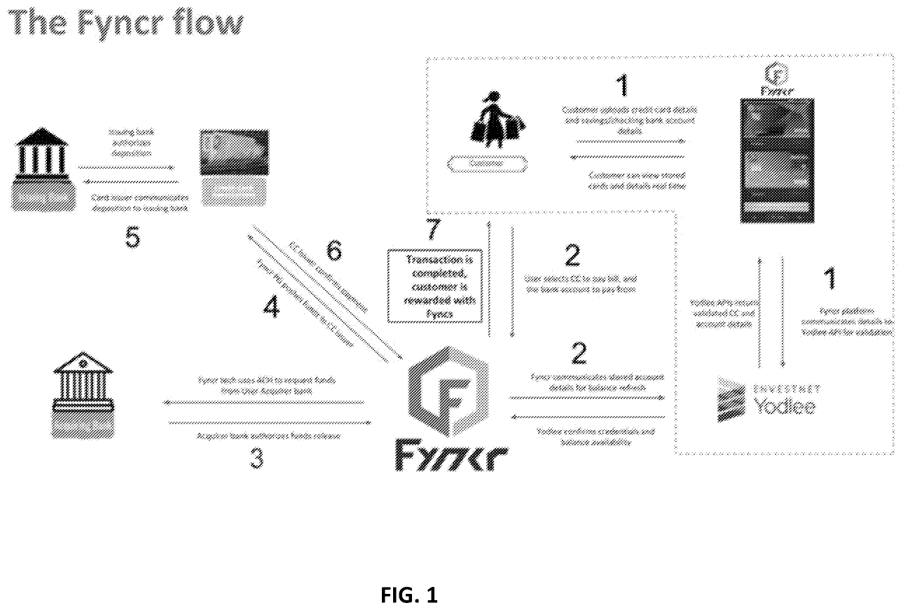

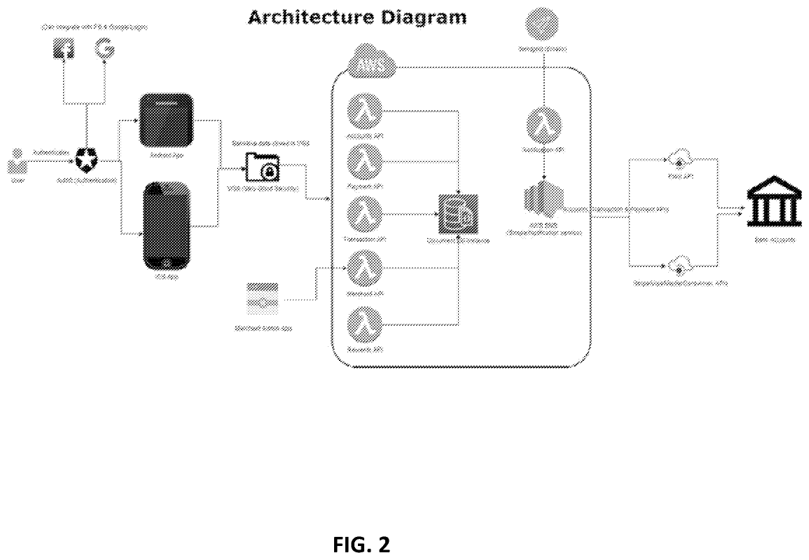

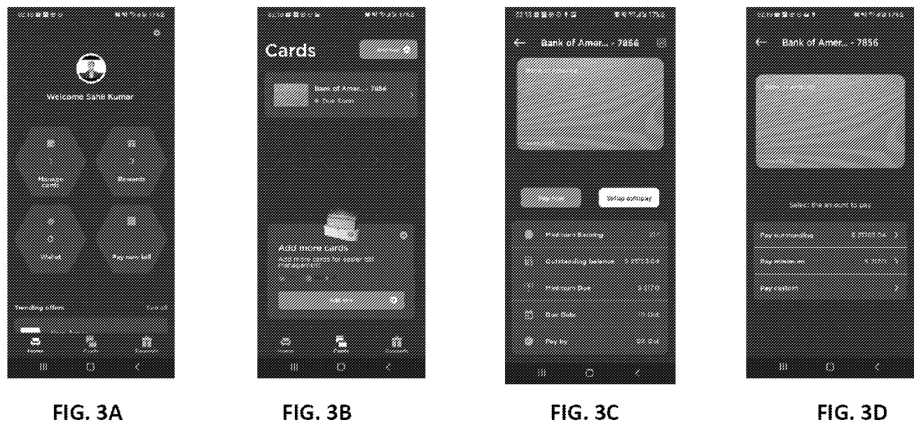

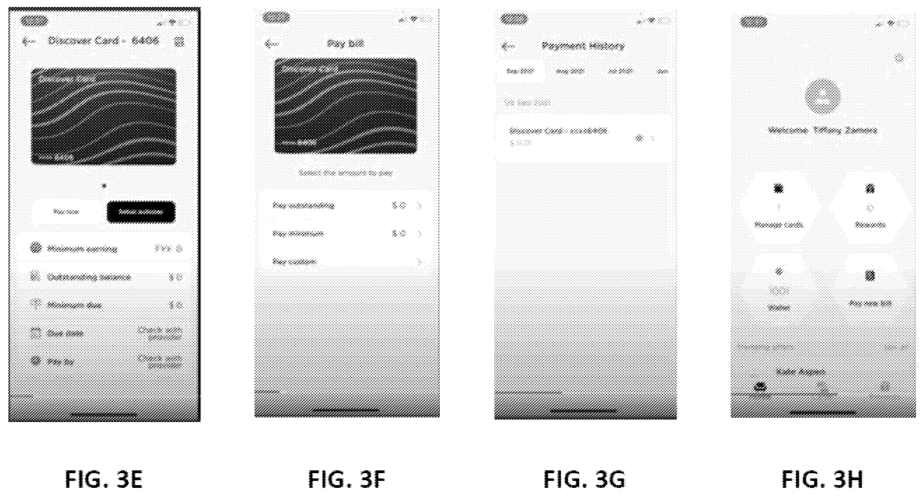

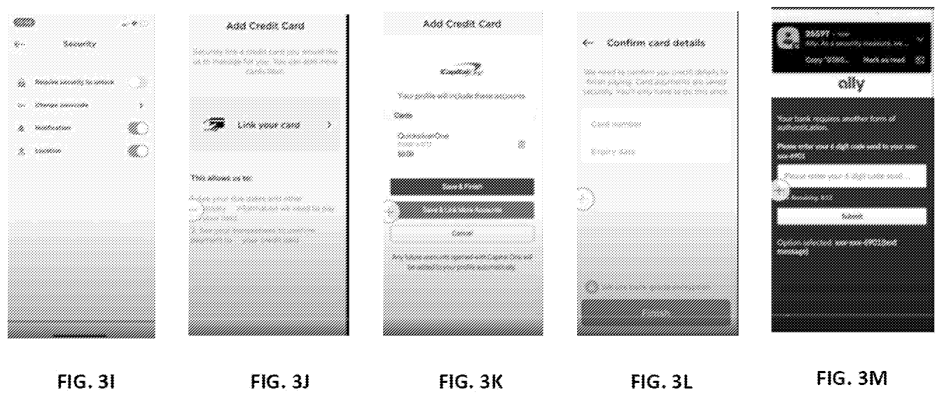

The present disclosure relates generally to methods and systems for managing multiple financial accounts and providing real-time incentives to users managing multiple financial accounts. Management systems may aggregate information from multiple credit card accounts, creating a single, uniform access point for the user to manage multiple accounts. Management systems may also facilitate making credit-card payments and may provide incentivizing rewards in response to particular user actions by monitoring user actions across multiple accounts and incentivizing aggregate behavior. FIG. 1 is a flowchart for an example system. Here, a user has multiple credit card accounts. For example, the user may have one or more store credit cards, e.g., provided by Best Buy™, Target™, or other retailers. The user may also have one or more credit cards issued by a financial institution, such as a savings bank or credit union. The credit cards may be associated with various payment network such as Visa™, MasterCard™, American Express™, or Discover™. One or more of the credit card accounts may have an outstanding balance or debt that the user is obligated to pay. Each credit card account may be associated with a separate and incompatible electronic payment and billing system, include disparate user portals, allowing the user to make payments or perform other financial transactions for a particular credit card account. The user may have to create a separate account for each billing system and associate the account with a particular credit card. For example, each credit card account may have one or more unique identifiers, such as the credit card number printed on the front of the card or the bank-account number associated with the credit card. Each billing system account can then be associated with a credit card by a unique identifier. Each billing system account may have its own unique security access protocol, such as password or multi-factor authentication, configured by the user. By providing the unique access credentials to each billing system, the user may access each individual account and perform financial transactions associated with the account, such as checking account balances or making required payments, for one credit card account at a time.

As shown in FIG. 1, a management system allows a user to effectively manage multiple credit card accounts. To enroll in the management system, the user may provide account identifiers for multiple credit card accounts to a management system. The account identifiers may include unique identifiers associated with each account and/or credentials for the associated electronic payment and billing system portal. The user may also provide information associated with a bank or similar savings institution, such as routing number and account number to the management system. In some examples, the user provides this information using an application associated with the management system and executing on a mobile device associated with the user. The application may be made available for download and installation on the user's mobile device, e.g., from an application store of the mobile device's vendor. The user may provide information to the application through a user interface displayed on the mobile device by the application. In some examples, the application displays a user interface allowing the user to add, delete, or edit account information. In this way, the user may manage the multiple credit card accounts, including, e.g., credit card accounts associated with multiple payment networks, multiple financial institutions and/or multiple retailers. The mobile device may encrypt or otherwise maintain the privacy of information provided by the user. For example, the secure information may be maintained in a Payment Card Industry (PCI) Data Security Standard (DSS) vault in encrypted format. The mobile device may transmit the information to the management system using a secure data transmission system, such as Very Good Security. The mobile device may also transmit information, e.g., credentials, associating the user with an account of the management system. These credentials may include multi-factor authentication. In this way, the user can access information related to all registered credit card accounts using a single sign-on. The users account on the management system may include additional user-identifying information such as birthday and/or government-issued identification number, such as a U.S. social security number or other tax ID provided by the user through the mobile device or through a web-based account-management portal provided by the management system.

In response to receiving information from the user, the management system may validate the credit card accounts and bank accounts, e.g., using account information and/or user-identifying information provided by the user. In some examples, the management system validates the accounts using a validation service, such as Yodlee. The management system may transmit validation information to the mobile device, indicating valid and invalid accounts. The application may indicate invalid accounts, so that the user can delete invalid accounts from the application or edit incorrect account-identifying information. Using unique identifiers associated with each valid account, the management system may determine, on an ongoing basis (e.g., daily), balances and transaction histories associated with each valid account. For example, the management system may access account information using the Plaid API to retrieve account type, balances, available balances, and recent transactions, among other values. The management system may transmit balances, payment due dates, minimum required payments, or other additional information to the mobile device. In response, the application may display aggregate and individual outstanding account balances, reminders of upcoming required payments, and other useful information. In this way, the user may effectively manage aggregate credit card balances and make timely minimum payments, avoiding penalties. In some examples, the application issues notifications to the user to remind the user of upcoming payment due dates or other important events, and/or incentive the user to take actions, such as to reduce outstanding balance, take advantage of merchant offerings, or redeem rewards earned by using the management system.

The application may display credit-card and bank account information to the user. The account information may include aggregate credit card account balances and/or individual credit-card account balances. The information may also include minimum required payments and due dates for each credit card account. In response, the user may select a payment account for one or more credit-card accounts. If the user has multiple bank accounts, the user may select one or more bank accounts to pay from. One payment account may be a floating account maintained by the management system for the user. Optionally, the user may also select a payment date. The system may be configured to implement the floating account as a proxy or pool node or point in the system. For example, the floating account can received funds from different consumer bank accounts and pool the funds in that accounts in the account using the infrastructure of the floating bank for the account and also be implemented to configure the floating account to transfer money or be the source of money to complete payments at the individual consumer level of each bank payments from the floating account. A batch process can be implemented using the system to larges batches of payments from the floating account and preferably the batch include individualized adaptations for each consumer payment to complete a credit card payment. The application may cause the mobile device to transmit the user selections to the management system. In response to receiving the user selections, the management system may transmit a request, such as an Automated Clearing House (ACH) file, to the electronic system associated with the floating bank, causing the electronic system to transfer funds from the selected payment account into the floating bank, if needed. The management system may also transmit a request to the electronic system associated with the floating bank, causing the electronic system to transfer funds to make a credit card payment, e.g., by transmitting an Remote Payment and Presentment Service (RPPS) request to an appropriate credit-card payment network. Having transmitted the request to make the credit card payment selected by the user, the management system may add a reward to the financial rewards account associated with the user. In some examples, the management system transmits a notification to the user in substantially real time indicating the reward earned by the user. The notification may be a message or graphical image displayed on the user interface of the mobile device. For example, the message may say “you have earned 100 reward points.” In some examples, the notification includes an e-mail or text message.

In some embodiments, the system is configured to issue a reward at or about the same time (immediately after) a user selects to pay a credit card on the system. For example, when a user selects on the interface to pay Card X $100 and take interaction steps to send the payment on the interface, the system is configured to immediately notify the user of a corresponding reward (e.g., reward points) for that action. The system is preferably configured to provide this notification and addition to the user's available rewards for consumption immediately (within 1-2 seconds or less) of the action by way of a popup on other notification in the visual screen that the user is currently viewing. This notification and addition is preferably implemented before the system has completed the money transfer from the user bank account, completed the money transfer from the floating account to the credit card issuing bank of that user, or confirmation or validation that the money has been transferred to the appropriate credit card account. The system is preferably configured to allow the user to spend the reward now before one or of the mentioned processes are completed as part of the interactive capability of the user interface. In this configuration, the system is configured to award the reward and allow the use of the spending but has the capability to check the status of the process thereafter and if there is a problem (e.g., bank account funds are insufficient), implement a process that reverses the issuance of the reward or the use of the reward to place the status of the reward back to the state before the payment was selected by the user. This feature can provide a significant technical advantage in it can result in a much higher level of use, interaction, and return to use in the system and its user interface.

In some examples, the management system includes a financial rewards account associated with each user. Each financial rewards account may include a cumulative amount of rewards earned by the user. Rewards may be also in the form of a national currency, such as a fiat currency, issued by a central bank or monetary authority. Rewards may be in the form of tokens redeemable through the management system, e.g., “points.” The management system may add rewards to a user's financial rewards account in response to actions taken by the user. The management system may use rewards to incentivize user actions. For example, the management system may add rewards when users purchase goods or services offered by a merchant whose goods or services are promoted by the management system. For example, the application may display merchant advertising or promotions to the user. Subsequently, the user may purchase goods or services associated with the merchant. In response to the user purchasing purchase goods or services associated with the merchant, the management system may add rewards to a financial rewards account associated with the user. The management system may add rewards to the user's financial rewards account in response to the user interacting with the application executing on the mobile device or performing transactions using the management system. For example, the management system may add rewards to the user's financial rewards account based on a percentage of the value of transactions performed using the management system or based on an amount of time the application is displays advertisement to the user. In some examples, when the user has earned a threshold level of rewards, the management system allows the user to redeem awards in the form of a “cash back” credit to a bank account. In some examples, the user may redeem rewards a threshold amount of time after they are earned, e.g. one month. In some examples, rewards are available to the user as soon as they are earned.

In some examples, the management system transfers funds into and out of a floating bank, i.e., a financial institution having an associated electronic system capable of receiving transfer requests from the management system. For example, the management system may send transfer requests, such as a wire transfer requests, to the electronic system of the floating bank to cause the electronic system to transfer funds to or from one or more bank account associated with the user. For example, the management system may transfer credit card account payments from the bank account and/or may transfer rewards into the bank account. The management system may send transfer requests through a communication network, such as the Internet, to the electronic system of the floating bank. In some examples, the transfer request includes an Automated Clearing House (ACH) file formatted by the management system and transferred using the Secure File Transfer Protocol (SFTP). The ACH file format may be customized or adapted by the management system to comply with requirements associated with particular user accounts. The management system may also send transfer requests to the electronic system of the floating bank causing the electronic system to transfer funds from the floating bank to a credit card account. For example, the electronic system may use the Remote Payment and Presentment Service (RPPS), or Visa ePay to transfer funds from the floating bank to credit card accounts associated with the user to make payments on behalf of the user. The RPPS file format may be customized or adapted by the management system to comply with requirements associated with particular user accounts, credit card accounts, payment network, or for other reasons. A common problem is that the existing online bank payments are configured to keep the user captive or linked to services or online payments services that are beneficial to the bank or financial institution. Another problem is that there is a huge array of different formats and system requirements for the valid payment of credit cards

To elaborate, in one or more embodiments of the present invention, a system is implemented using software and hardware that implements technology to open the user's access via its structure. For example, a mobile application (or if desired, application through a browser) is implemented that displays to the user various user interfaces, options, screen, etc. In some embodiments, the system is configured to provide the user the ability to connect to a data aggregator service (which may have its own servers and interface screens) through a portal (e.g., portal window) displayed to the user. The user can enter his or her account information such as their online credit card account login and password that is entered in the system but the system is configured to only have access to that information in encrypted form (e.g., as the user types in the data, a software process enters not the login area and blocks a view of the text and does not save the data unless encrypted for retrieval. The user can login through the aggregator service (aggregator of credit card account information for consumer in a format that is standardized across different credit cards for third party access) or can be configured to login into the credit card account directly through the portal. The system can be configured to allow the user to authorize the system to access that user's credit card account information on an ongoing basis after the login without requiring the system to use or enter the user's login and password. The system can then use the aggregator service to access account information (e.g., daily, monthly, hours, etc.) If preferred, the system can be configured to login to the user's credit card account to retrieve credit card account information.

In one or embodiments, the system is configured to store a database of requirements and possibly other information for each credit card (e.g., Capital One versus American Express Gold) that is required to configure RPPS messages or process to complete a valid money transfer to a user's credit card account. Each bank, credit card and/or gateway may require different information and may require different message structures or formats. The system is configured to receive the request to pay a particular user's credit card account and the amount and in response, configure the RPPS process using the database to be compliant for that bank, gateway, and/or credit card. The system (generally understood to include a server) is configured to operate with the system of the floating bank and is configured to instruct, control, and/or adapt operations by or at the bank system to carry out the RPPS process at the bank (and ACH process) at the bank system. Further, the system can be configured to generate status flags or information at each stage and report that information e.g., via a notification to the user in the mobile app (or browser, email etc.). In some embodiments, the system is configured to (in response to initiation and performance of an RPPS (money transfer) execute a software process that access the user's credit card account information (or other resource) such as by accessing the data provided by the aggregator service and comparing information in the user account to the information that was used in paying the account. The aggregator service may provide lower level details about received payments such as source of payment, time of payment, or notes. The system is configured to compare the payment information (and/or RPPS contained information) to the account information to determine whether the payment was received in the account. If received, the system is configured to issue a notification such as in the mobile application that the payment was completed or if not verified by a certain time period, the system automatically initially performs additional steps. The illustrative system is configured to provide open access and transparency (real time or continuous update of status) in connection with live rewards interaction.

The application may display a user interface allowing the user to configure the management system to perform automatic payments. For example, the user may configure the management system to automatically pay the minimum required payment for each credit-card account on or before the due date for the minimum payment. The user may configure the management system to make full payments for all credit cards on or before the due date or make full payments only for selected cards. Other automatic-payment configurations are within the scope of the disclosure. The mobile device may transmit the automatic-payment configuration to the management system to schedule automatic payments for subsequent processing. When a scheduled automatic payment becomes due, the management system processes the automatic payment substantially the same as the manual process described above.

In some examples, the management system tracks fund transfers to determine whether the transfer was effective. For example, the management system may monitor Notice of Change (NOC) reports indicating an issue associated with one or more ACH. In response to receiving a NOC, the management system may transmit a notification to the user and/or retry transferring the funds. The management system may determine account balances on an ongoing basis, as described above, to reconcile transfers initiated by the management system with changes to the accounts. If a transaction initiated by the management system cannot be reconciled, the management system may transmit a notification to the user and/or reperform the failed transaction. If the transaction cannot be reperformed, the management system may roll back associated transactions to balance the ledger. For example, if a credit-card account payment continues to be ineffective, the management system may roll back the transfer of funds from the user account associated with the attempted credit-card account payment. Alternatively, the management system may credit the user's floating account by the equivalent amount or take other action to reconcile the user's account in light of the failed transaction. For example, the management system may reduce or eliminated the reward associated with the failed transaction. In some examples, the management system performs the process of reconciling initiated transactions against bank information hourly or using other periods (e.g., daily).

In some examples, the management system receives merchant information, e.g., information associated with a promotional program involving goods or services offered by the merchant. The merchant information may include merchant incentives, such as a limited-time sale price, cash back, or other incentive for the user to purchase goods and services. The merchant information may include advertising that may be displayed to the user, e.g., on the display of the mobile device associated with the user. In response to receiving the merchant information, the management system may transmit some or all of the merchant information to the mobile device. For example, the management system may transmit the advertisement or information related to the incentives for the user to purchase goods and services. In some examples, the management system may transmit a notification to the user, such as an e-mail or text message transmitted to the mobile device. If, during a promotional period, the user purchases the promoted goods or services, the management system may add a reward to the financial rewards account associated with the user.

In some embodiments, the system is configured to install or implement hardware and/or software on the bank system (e.g., its servers). The communication connection between the system and the bank is over a secure private financial network that is configured to meet the security required by the financial institution and the payment system is configured as a network client on that network that meets the requirement for the network and the bank/financial institution. With the use of APIs of the bank's system or hardware/software module(s) installed on the bank system (e.g., potentially behind firewalls), the system is configured to for example carry out the ACH and RPPS operations over/on the bank system using the APIs/modules. For example, a remote-controlled operation. In some embodiments, the system is configured to include an application in which software modules or elements of the application are running on modules, servers, or equipment on the bank system using which application the system can automate, configure, and control the operation of money transfer to be performed and be valid and implemented in accordance with the necessary requirements. In some implementations, the system and bank system can be collocated or integrated as one but in the preferred embodiment (but not limited as such) system and the bank system are separate third party system operating in under independent domains but are connected over a network.

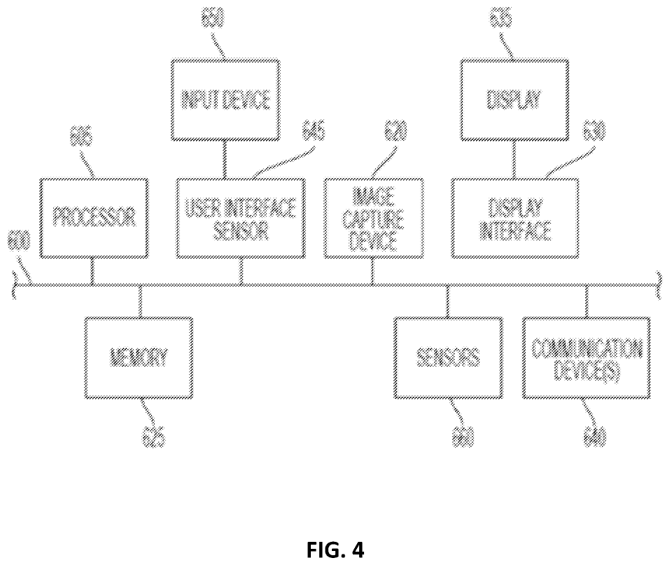

FIG. 6 depicts an example of internal hardware that may be included in any of the electronic components of the system. An electrical bus 600 serves as an information highway interconnecting the other illustrated components of the hardware. Processor 605 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 625. A memory device may include a single device or a collection of devices across which data and/or instructions are stored. Various embodiments of the invention may include a computer-readable medium containing programming instructions that are configured to cause one or more processors to perform the functions described in the context of the previous figures and in the application. The memory or computer-readable medium for storing instructions can be nonvolatile or non-transitory.

An optional display interface 630 may permit information from the bus 600 to be displayed on a display device 635 in visual, graphic or alphanumeric format, such on an in-dashboard display system of the vehicle. An audio interface and audio output (such as a speaker) also may be provided. Communication with external devices may occur using various communication devices 640 such as a wireless antenna, a radio frequency identification (RFID) tag and/or short-range or near-field communication transceiver, each of which may optionally communicatively connect with other components of the device via one or more communication system. The communication device(s) 640 may be configured to be communicatively connected to a communications network, such as the Internet, a local area network or a cellular telephone data network.

The hardware may also include a user interface sensor 645 that allows for receipt of data from input devices 650 such as a keyboard or keypad, a joystick, a touchscreen, a touch pad, a remote control, a pointing device and/or microphone. Digital image frames also may be received from a camera 620 that can capture video and/or still images. The system also may receive data from one or more sensors 660 such as electromagnetic sensors.

The system can provide advantage over prior systems in this field by providing an automated advanced router that can adapt messages, signals, or content of message to direct it (automatically) to the appropriate destination and/or protocol or network to complete money transfers and update status (such real time or live update of credit card account). In other aspects, the system operates as an overly system that is adapted to consolidate the operation across multiple related system to manage and complete the payments (from bank accounts) into appropriate receivers on the payment network, which can adjust for many existing technical and procedural challenges. The system can be configured to programmable/updated so as to provide a universal system for handling new card, new bank accounts, and changes in underlying procedures.

It is understood from the above description that the functionality and features of the systems, devices, or methods of embodiments of the present invention include generating and sending signals to accomplish the actions.

Thus, for example, any sequence(s) and/or temporal order of steps of various processes or methods (or sequence of device connections or operation) that are described herein are illustrative and should not be interpreted as being restrictive. Accordingly, it should be understood that although steps of various processes or methods or connections or sequence of operations may be shown and described as being in a sequence or temporal order, but they are not necessarily limited to being carried out in any particular sequence or order. For example, the steps in such processes or methods generally may be carried out in various different sequences and orders, while still falling within the scope of the present invention. Moreover, in some discussions, it would be evident to those of ordinary skill in the art that a subsequent action, process, or feature is in response to an earlier action, process, or feature.

It is also implicit and understood that the applications or systems illustratively described herein provide computer-implemented functionality that automatically performs a process or process steps unless the description explicitly describes user intervention or manual operation.

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

It should be understood that combinations of described features or steps are contemplated even if they are not described directly together or not in the same context.

The words “may” and “can” are used in the present description to indicate that this is one embodiment, but the description should not be understood to be the only embodiment.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention. Applications of the technology to other fields are also contemplated.

1. A method of providing an incentive, comprising:
receiving, at a data processing device, one or more account identifiers, each account identifier identifying a financial account associated with a user;
receiving, at the data processing device, a payment request comprising a payment amount, a credit account selection from the one or more account identifiers, and a payment account selection from the one or more account identifiers;
upon receiving the payment request:
transmitting, by the data processing device, a first financial transfer request to an electronic system associated with a bank account, the first financial transfer request causing the bank account to receive a first payment from the selected payment account; and
transmitting, by the data processing device, a second financial transfer request to the electronic system associated with the bank account, the second financial transfer request causing the electronic system to transfer a second payment to the selected credit account;
generating, by the data processing device, the incentive based on the payment amount; and
providing, by the data processing device, an incentive notification to the user.

2. The method of providing an incentive of claim 1, further comprising:
receiving from the user, at the data processing device, credentials associated with the selected credit account; and
validating, by the data processing device, the received credentials prior to transmitting the first financial transfer request.

3. The method of providing an incentive of claim 2, wherein validating the received credentials comprises transmitting a validation request to an account validation service, the validation request causing the account validation service to validate the received credentials.

4. The method of claim 1, further comprising:
receiving, at the data processing device, an indication that the second payment was not credited to the selected credit account; and
in response to the indication, diminishing, by the data processing device, the incentive.

5. The method of claim 1, further comprising:
receiving, at the data processing device, merchant program information indicating one or more products or services associated with the merchant; and
in response to determining, by the data processing device, that at least a portion of the second payment is for a product or service associated with the merchant, increasing the incentive.

6. The method of claim 5, further comprising transmitting to the user, by the data processing device, a merchant program message indicating one or more of the one or more products or services associated with the merchant.

7. The method of claim 1, further comprising transmitting to the user, by the data processing device, an incentive message indicating the generated incentive.

8. The method of claim 7, wherein the incentive message comprises an email message.

9. The method of claim 1, wherein the payment request comprises an autopayment request.

10. The method of claim 1, wherein the incentive notification is provided substantially contemporaneously with receiving the payment request.

11. The method of claim 1, wherein the bank account is a floating bank account.

12. A system comprising:
a data processing device and a non-transitory computer-readable medium in communication with the data processing device, the data processing device configured to perform operations comprising:
receiving one or more account identifiers, each account identifier identifying a financial account associated with a user;
receiving, at the data processing device, a payment request comprising a payment amount, a credit account selection from the one or more account identifiers, and a payment account selection from the one or more account identifiers;
upon receiving the payment request:
transmitting, by the data processing device, a first financial transfer request to an electronic system associated with a bank account, the first financial transfer request causing the bank account to receive a first payment from the selected payment account; and
transmitting, by the data processing device, a second financial transfer request to the electronic system associated with the bank account, the second financial transfer request causing the electronic system to transfer a second payment to the selected credit account;
generating, by the data processing device, an incentive based on the payment amount; and
providing, by the data processing device, an incentive notification to the user.

13. The system of claim 12, wherein the data processing device is further configured to perform operations comprising:
receiving from the user, at the data processing device, credentials associated with the selected credit account; and
validating, by the data processing device, the received credentials prior to transmitting the first financial transfer request.

14. The system of claim 12, wherein validating the received credentials comprises transmitting a validation request to an account validation service, the validation request causing the account validation service to validate the received credentials.

15. The system of claim 12, wherein the data processing device is further configured to perform operations comprising:
receiving, at the data processing device, an indication that the second payment was not credited to the selected credit account; and
in response to the indication, diminishing, by the data processing device, the incentive.

16. The system of claim 12, wherein the data processing device is further configured to perform operations comprising:
receiving, at the data processing device, merchant program information indicating one or more products or services associated with the merchant; and
in response to determining, by the data processing device, that at least a portion of the second payment is for a product or service associated with the merchant, increasing the incentive.

17. The system of claim 16, wherein the data processing device is further configured to perform operations comprising:
transmitting to the user, by the data processing device, a merchant program message indicating one or more of the one or more products or services associated with the merchant.

18. The system of claim 16, wherein the data processing device is further configured to perform operations comprising:
transmitting to the user, by the data processing device, an incentive message indicating the generated incentive.

19. The system of claim 12, wherein the incentive notification is provided substantially contemporaneously with receiving the payment request.

20. The system of claim 12, wherein the bank account is a floating bank account.
